(19) United States
(12) Patent Application Publication
(10) Pub. No.: US 2003/0035062 A1
(43) Pub. Date: Feb. 20, 2003

(54) Apparatus and method for displaying an image on a display screen

(76) Inventor: Peter Flamm, March (DE)

Correspondence Address: Samuels, Gauthier & Stevens LLP, Suite 3300, 225 Franklin Street, Boston, MA, 02110, US

(21) Appl. No.: 10/178,058

(22) Filed: Jun. 21, 2002

(30) Foreign Application Priority Data
Jun. 21, 2001 (DE) 101 29 917.6

(51) Int. Cl. H04N 5/68; H04N 3/223

(52) U.S. Cl. 348/380; 348/704; 348/206

(57) ABSTRACT

The invention relates to a method for displaying a television picture or monitor picture on a display screen. In order to achieve a largely line-free display while degrading the vertical contrast of the picture as little as possible, an approach is proposed in which a vertical contrast value is determined from a video input signal (Y), the vertical contrast value is compared with a limiting value (a, b), and a vertical widening of a light spot region of the lines covered by the scanning beam is set as a function of this comparison, preferably by a vertical sweep of the scanning beam. If the vertical contrast value is below the limiting value (a, b), a smaller vertical widening of the light spot region is set than if the vertical contrast value is above the limiting value (a, b).

### BACKGROUND OF THE INVENTION

The invention relates to a method and a device for displaying a television picture or monitor picture on a display screen.

When an image is reproduced on a display screen of a cathode ray tube, for example, in a television set or monitor, the light spot defined by the scanning beam generally does not completely fill the line region provided for the intended line. The result is often a worsening of the picture as perceived by the viewer.

However, there are known measures by which the television or monitor image may be reproduced line-free. First, the vertical deflection can be swept at such a high frequency, i.e., periodically deflected, that the wandering light spot fills out the line region. Second, the light spot may be distorted in the vertical axis, for example, forming an ellipse. Both techniques cause the gaps between the light spot regions to disappear.

A disadvantage of such measures, however, is the fact that image sharpness is reduced in the vertical axis, i.e., fine structures in the vertical axis are reproduced with a more blurred appearance.

Therefore, there is a need for an apparatus and method of displaying an image on a display screen that enables at least a largely line-free display while reducing impairment of the vertical contrast of the picture.

### SUMMARY OF THE INVENTION

A determination is made whether the display image has a sufficiently high vertical contrast that the image display may be degraded by a vertical widening. Based on this determination, a vertical widening of the light spot is effected as necessary.

A vertical contrast value is determined from the video input signal. This may be achieved by comparing different lines of the image in which the video input signal is delayed and forming a difference between the video input signal and the delayed video input signal. The period of the delay may, for example, be one line so that successive lines are compared. This is useful especially for progressive signals. Alternatively, for example, for interlaced signals, the delay may be one field plus or minus one half line so that in the PAL system, for example, a delay is 312 or 313 lines.

The difference determined between the delayed and undelayed video input signals is taken, according to the invention, as a measure of the required vertical widening. By comparing the vertical contrast value with one or more limiting values, a determination can be made whether the vertical extent of the illuminated region, or the light spot region, must be widened.

This widening may be performed by distortion of the light spot in the vertical axis.

Preferably, a sweep is performed, however, i.e., a periodic deflection of the scanning beam at a sufficiently high frequency that line region of the display screen may be covered in the desired manner by the swept scanning beam. To achieve this, the sweep frequency is preferably higher than the pixel frequency.

This deflection of the scanning beam may be performed by the existing vertical deflector coil of the cathode ray tube or by additional deflector coils. For this purpose, a sweep signal is modulated at a sufficiently high frequency. This modulation may be achieved by having a function device generate a modulation signal as a function of the vertical contrast signal which is superimposed in a modulation device on the sweep signal, for example by multiplication.

The function device that receives the vertical contrast signal and outputs the modulation signal generally has a nonlinear characteristic here. Preferably no sweep of the scanning beam above an upper limiting value is performed so that the function device outputs a modulation signal with the value zero. Below a lower limiting value at which a sufficiently low-vertical-contrast image is present, the maximum sweep can be effected so that the function device outputs a maximum modulation signal to the modulation device. By having a linear transition between the two limiting values, a function device with a trapezoidal characteristic may be used. Alternatively, other characteristics may be used, however, which have proven useful in practical tests.

These and other objects, features and advantages of the present invention will become more apparent in light of the following detailed description of preferred embodiments thereof, as illustrated in the accompanying drawings.

### BRIEF DESCRIPTION OF THE DRAWING

FIG. 1 is a block diagram illustration of a device based on one embodiment of the invention;

FIG. 2 shows a characteristic of a function device in this device.

### DETAILED DESCRIPTION OF THE INVENTION

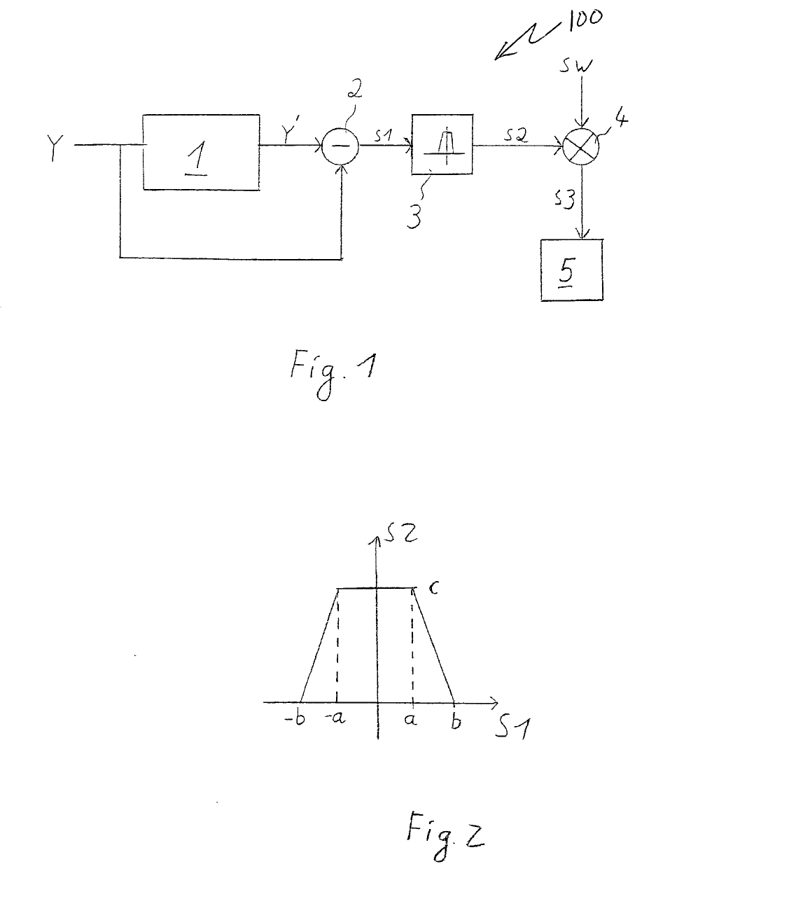

FIG. 1 is a functional block diagram illustration. The device 100 includes a delay device 1 that receives a video input signal Y and outputs a delayed video input signal Ý. Any television or video signal, especially an RGB signal or one of the three signals R, G, and B may be used here. The delay may, for example, be one line in a progressive signal and one field plus or minus a half line in an interlaced signal so that in the PAL system, for example, it is 312 or 313 lines.

The undelayed video input signal Y and the delayed video input signal Ý are fed to a difference-forming device 2, such as a subtracter, which subtracts the two signals and determines the vertical contrast value that is transmitted as a vertical contrast signal s1 to a function device 3. The function device 3 outputs a modulation signal s2 as a function of the vertical contrast signal s1. The output characteristic for function device 3 is seen in FIG. 2 in which the value for the modulation signal s2 is shown as a function of the vertical contrast value. Additional values are the lower limiting value a and the upper limiting value b. Given a vertical contrast value of less than −b or more than b, a modulation signal s2 of value zero is output. Given a vertical contrast value between −a and a, a modulation signal with a maximum value c is output. Between these ranges, i.e., for vertical contrast values between a and b, a suitable transition is selected which is linear as shown in FIG. 2.

The function device 3 transmits modulation signal s2 to a modulator 4 which may be a multiplier. The modulator then receives a periodically varying sweep signal sw, the frequency of which is higher than the pixel frequency. A modulated sweep signal s3 is generated by multiplication and fed to vertical deflector coils 5.

Although the present invention has been shown and described with respect to several preferred embodiments thereof, various changes, omissions and additions to the form and detail thereof, may be made therein, without departing from the spirit and scope of the invention.

What is claimed is:

1. Method for displaying a television picture or monitor picture on a display screen in which, a vertical contrast value is determined from a video input signal (Y), the vertical contrast value is compared with a limiting value (a, b) and vertical widening is set for a light spot region of the lines covered by the scanning beam as a function of this comparison, wherein a smaller vertical widening of the light spot region is set if the amount of the vertical contrast value is below the limiting value (a, b) than if the amount of the vertical contrast value is above the limiting value (a, b).

2. Method according to claim 1, characterized in that the vertical widening of the light spot region is performed by a period vertical deflection of the scanning beam within the line region and/or by a vertical distortion of the scanning beam within the line region.

3. Method according to claim 2, characterized in that an upper limiting value (b) is provided wherein no vertical widening of the light spot region is performed for those vertical contrast values above the upper limiting value (b).

4. Method according to claim 3, characterized in that a lower limiting value (a) is provided wherein a constant vertical widening of the light spot region is performed for those vertical contrast values below the lower limiting value (b).

5. Method according to claim 4, characterized in that the vertical widening of the light spot region is performed for those vertical contrast values below the lower limiting value (b) in such a way that the light spot region fills out the line region of the television or monitor display screen, at least to a considerable extent and preferably completely.

6. Method according to claim 5, characterized in that a vertical widening decreasing with the vertical contrast value, preferably decreasing linearly, of the light spot region is performed between the lower limiting value and the upper limiting value.

7. Method according to claim 6, characterized in that the vertical contrast value is determined from a difference between the video input signal (Y) and a time-delayed video input signal (Ý).

8. Method according to claim 7, characterized in that the time delay amounts to one line, or one field plus one half line, or one field minus one half line.

9. Method according to claim 1, characterized in that a vertical contrast signal (s1) corresponding to the vertical contrast value is output and a modulation signal (s2) generated as a function of the vertical contrast signal, and that the modulation signal (s2) is superimposed on a sweep signal (sw) for a periodic deflection, preferably by multiplication, and a modulated sweep signal (s3) is fed to a vertical deflector coil.

10. Method according to claim 9, characterized in that the modulated sweep signal (s3) is amplified and superimposed on a vertical deflection signal for the scanning beam or fed to a separate vertical deflector coil.

11. Device for displaying a television picture or monitor picture on a display screen, comprising:
a contrast-determining device (1, 2) to receive a video input signal (Y), calculate a vertical contrast value, and output a vertical contrast signal (S1) corresponding to the vertical contrast value,
a function device (3) to receive the vertical contrast signal (s1) and output a modulation signal (S2) as a function of a comparison of the vertical contrast value with at least one limiting value (a, b),
a device modifying the scanning beam (4, 5) to receive the modulation signal (S2) and vertical widening of the light spot region as a function of the modulation signal,
wherein a smaller vertical widening of the light spot region may be implemented if the vertical contrast value (a, b) is below the limiting value than if the vertical contrast value is above the limiting value (a, b).

12. Device according to claim 11, characterized in that the device modifying the scanning beam outputs a sweep signal (sw) for a periodic deflection.

13. Device according to claim 12, characterized in that the contrast-determining device has a delay device (1) to receive the video signal (Y) and output a delayed video signal (Ý), and a difference-forming device (2) to receive the video signal (Y) and the delayed video signal (Ý), and to output a vertical contrast signal (S1).

14. Device according to claim 13, characterized in that the device modifying the scanning beam (4, 5) has a modulation device (4) to receive a modulation signal (s2) and a sweep signal (sw), and to output a modulated sweep signal (s3).

15. Device according to claim 14, characterized in that a maximum modulation signal may be output if the vertical contrast value falls below a lower limiting value (a).

16. Device according to claim 15, characterized in that a modulation signal with the value zero may be output if the vertical contrast value exceeds an upper limiting value (b).

17. Device according to claim 16, characterized in that a modulation signal decreasing with the vertical contrast value, preferably one decreasing linearly, may be output if the vertical contrast value lies between a lower limiting value (a) and an upper limiting value (b).
